(19) United States
(12) Patent Application Publication
(10) Pub. No.: US 2014/0330669 A1
(43) Pub. Date: Nov. 6, 2014

(54) LEVERAGING READER PERFORMANCE TO PROVIDE A PUBLICATION RECOMMENDATION

(71) Applicants: EDWIN J. BRUCE, CORINTH, TX (US); CHRISTOPHER M. BRUNET, PHILADELPHIA, PA (US); ROMELIA H. FLORES, KELLER, TX (US); JAMES R. MICHELICH, ARMONK, NY (US)

(72) Inventors: EDWIN J. BRUCE, CORINTH, TX (US); CHRISTOPHER M. BRUNET, PHILADELPHIA, PA (US); ROMELIA H. FLORES, KELLER, TX (US); JAMES R. MICHELICH, ARMONK, NY (US)

(73) Assignee: INTERNATIONAL BUSINESS MACHINES CORPORATION, ARMONK, NY (US)

(21) Appl. No.: 13/874,863

(22) Filed: May 1, 2013

(51) Int. Cl. G06Q 30/06

(52) U.S. Cl. CPC G06Q 30/0631
USPC 705/26.7

(57) ABSTRACT

A user associated with an educational institution is identified. The institution can include a curriculum. The user can be associated with a profile. The profile can include characteristics associated with the user. The characteristics can include a skill associated with the curriculum and a performance indicator associated with the skill. The skill can be a learned capacity to carry out a pre-determined result. The characteristics can be analyzed to determine a proficiency or a deficiency in the skill. The analyzing can evaluate the performance metric. An enhancement data associated with a publication within a publication repository can be determined. The enhancement data can include target skill and a target characteristic. The publication repository can be an electronic catalog and/or a physical library. The publication can be a physical media and an electronic media.

### BACKGROUND

The present invention relates to the field of education and, more particularly, to leveraging reader performance to provide a publication recommendation.

Young students (e.g., ages two through thirteen) traditionally rely on adults such as teachers and/or librarians to help them to select books to read. Frequently, adults are unable to determine appropriate books to assign students because each student is unique and responds differently to different books. In many cases, guidelines exist to give reading selectors (e.g., adults) ideas for which age groups particular books are appropriate. However, this process fails to account for an individual student's current classroom focus (e.g., spelling or writing techniques) in order to provide reading that is immediately relevant and aligned with subject matter currently being taught to the student.

Secondary solutions for students to utilize include Web sites which provide recommendations based on titles and/or authors. Book recommendations can be based on a shopper's purchase history, books the shopper has viewed but not purchased, and the purchase histories of other customers. Some Web sites base recommendations on books a user has already read. Traditional solutions, however, fail to address the problem of reader proficiency which can recommend books which the user may be unable to comprehend and/or read (e.g., complex sentence structures). As such, a revolutionary step forward in addressing the previously-highlighted shortcomings associated with present-day approaches is required.

### BRIEF SUMMARY

One aspect of the present invention can include a system, an apparatus, a computer program product, and a method for leveraging reader performance to provide a publication recommendation. A user associated with an educational institution is identified. The institution can include a curriculum. The user can be associated with a profile. The profile can include characteristics associated with the user. The characteristics can include a skill associated with the curriculum and a performance indicator associated with the skill. The characteristics can be analyzed to determine a proficiency or a deficiency in the skill. The analyzing can evaluate the performance metric. An enhancement data associated with a publication within a publication repository can be determined. The enhancement data can include target skill and a target characteristic. The publication repository can be an electronic catalog and/or a physical library. The publication can be a physical media and/or an electronic media.

Another aspect of the present invention can include an apparatus, a computer program product, a method, and a system for leveraging reader performance to provide a publication recommendation. A recommendation engine can be configured to provide a recommendation report based on a reader. The recommendation report can include recommended publications associated with characteristics of the reader. The characteristics can be a skill associated with a subject area of a curriculum and/or a performance indicator associated with the skill. The skill can be a learned capacity to carry out pre-determined result. A data store can persist a curriculum, a publication recommendation, a reader profile, and/or a configuration setting.

Yet another aspect of the present invention can include a computer program product that includes a computer readable storage medium having embedded computer usable program code. The computer usable program code can be configured to receive input from a user. The user input can be a search criteria which can include characteristics associated with a reader. The characteristics can include a grade level and/or a skill proficiency associated with a reader. The computer usable program code can be configured to query a publication repository to determine a publication appropriate for the reader based on the characteristic. The computer usable program code can be configured to present a result associated with the query. The result can be a recommended publication based on the search criteria. The recommended publication can be a physical media and/or an electronic media which upon interaction with the recommended publication can result in improving a characteristic associated with the reader.

### BRIEF DESCRIPTION OF THE SEVERAL VIEWS OF THE DRAWINGS

FIG. 1 is a schematic diagram illustrating a set of scenarios for leveraging reader performance to provide a publication recommendation in accordance with an embodiment of the inventive arrangements disclosed herein.

FIG. 2 is a flowchart illustrating a method for leveraging reader performance to provide a publication recommendation in accordance with an embodiment of the inventive arrangements disclosed herein.

FIG. 3 is a schematic diagram illustrating a system for leveraging reader performance to provide a publication recommendation in accordance with an embodiment of the inventive arrangements disclosed herein.

FIG. 4 is a schematic diagram illustrating a set of interfaces for leveraging reader performance to provide a publication recommendation in accordance with an embodiment of the inventive arrangements disclosed herein.

FIG. 5 is a schematic diagram illustrating an embodiment for leveraging reader performance to provide a publication recommendation in accordance with an embodiment of the inventive arrangements disclosed herein.

FIG. 6 is a schematic diagram illustrating an embodiment for leveraging reader performance to provide a publication recommendation in accordance with an embodiment of the inventive arrangements disclosed herein.

### DETAILED DESCRIPTION

The present disclosure is a solution for leveraging reader performance to provide a publication recommendation. In the solution, a reader profile can be established for a reader. The reader profile can include automatically and/or manually collected information about the reader, reading comprehension, curriculum information (e.g., current classroom focus), performance indicators (e.g., standardized test results), presence information (e.g., access to localized book repositories), and the like. The profile can be utilized to generate a recommendation report which can present highly relevant reader specific publication suggestions to improve and/or enhance reader performance. For example, the disclosure can suggest one or more books which can help a student reinforce material learned within a classroom.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

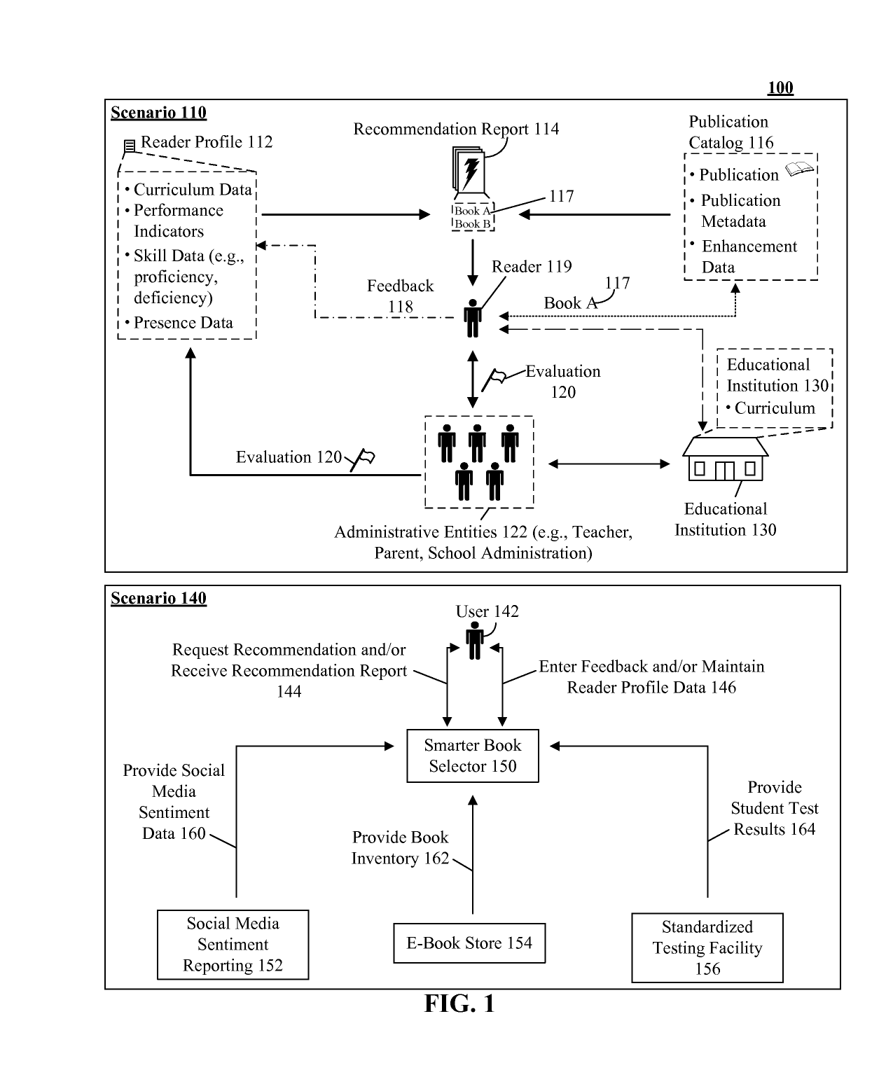

FIG. 1 is a schematic diagram illustrating a set of scenarios 110, 140 for leveraging reader performance to provide a publication recommendation in accordance with an embodiment of the inventive arrangements disclosed herein. Scenario 110 can illustrate a usage of the disclosure permitting a reader 119 to enhance performance and/or productivity through the use of recommendation report 114. For example, a recommendation 117 can be utilized to target a skill deficiency associated with a student. Scenario 140 can illustrate a user centric flow associated with the disclosure permitting a smarter book selector 150 to add value to analysis of social media sentiment, student test results, historic recommendations, and the like. For example and from scenario 110, a user (e.g., an administrative entity 122) can utilize selector 150 to provide a recommendation report 114 to a reader 119.

As used herein, educational institution 130 can be a public and/or private institution of learning. Institution 130 can include, but is not limited to pre-schools, childcares, elementary schools, primary schools, secondary schools, colleges, universities, academies, and the like. For example, institution 130 can be a school at which reader 119 is enrolled. Institution 130 can include, but is not limited to a curriculum, an administrative entity 122, and the like. For example, institution 130 can include teachers and/or administrative personnel (e.g., tutors, librarians) which aid the reader 119 in learning during reader 119 enrollment in a history course. Curriculum can be a set of courses and/or course content provided at institution 130. Curriculum can include, but is not limited to, a mandatory course, an optional course, a syllabus, and the like. In one embodiment, institution 130 can be associated with a publication catalog 116. For example, institution 130 can include a privately owned/operated library such as a university library.

Publication catalog 116 can be one or more repositories associated with storing and/or retrieving a publication. Catalog 116 can include, but is not limited to, a library, an electronic book catalog, and the like. In one instance, catalog 116 can include a Web site with an electronic book store (e.g., AMAZON.COM). Catalog 116 can include, but is not limited to a publication (e.g., magazine), publication metadata (e.g., publication date, genre), and the like. For example, catalog 116 can include bibliographic information of a physical library catalog stored within an electronic format (e.g., electronic catalog). Publication can be content which can be accessible to a public entity (e.g., general public, universities). Publication metadata can be bibliographic information which can be associated with a publication. Metadata can include, but is not limited to, enumerative bibliographic information, descriptive bibliographic information, and the like. Enumerative bibliographic information can include, but is not limited to, an author, a printer (e.g., publisher), a period of production, a subject, a genre, a date, a topic, a volume, a page range, and the like. Descriptive bibliographic information can include, but is not limited to, a format, a collation, a pagination, a binding, a title page transcription, a contents, a paper descriptor, an illustration descriptor, a presswork information, and the like.

As used herein, a skill can be a learned capacity to carry out pre-determined results. In one instance, a skill can be associated with a skill deficiency and a skill proficiency. In one embodiment, publication can be associated with an enhancement data which can be data indicating skills associated with interacting (e.g., reading, comprehending) with the publication. In the embodiment, enhancement data can include one or more criteria associated with identifying a skill which can be improved by the publication. Enhancement data can include, but is not limited to, a subject, a topic, a skill, an educational stage (e.g., 4th grade), and the like. That is, the enhancement data can be leveraged to determine publications which can improve reader skills (e.g., improving a deficiency). In one instance, enhancement data can include a requirement baseline which a reader must achieve to successfully interact (e.g., read) the publication. In the instance, the baseline can be a metric, a skill proficiency, and the like.

In the scenario 110, a reader 119 can be associated with a reader profile 112 which can be an explicit and/or implicit representation of reader 119's identity and/or capabilities. Profile 112 can include, but is not limited to, curriculum data (e.g., courses currently enrolled), skill data (e.g., proficiency, deficiency), performance indicators (e.g., test scores), presence data (e.g., on campus), and the like. For example, profile 112 can indicate the reader's age, grade level, and current reading skills. Skills can include, but is not limited to, language skills, mathematic skills, literacy skills, and the like. Language skills can include, but is not limited to, reading, reading comprehension, spelling, vocabulary, dyslexia, and the like. In one embodiment, profile 112 can include skill data which can indicate a skill deficiency and/or proficiency which can indicate a skill which can be targeted for improvement. In the embodiment, skill data can include a skill identifier, a topic identifier, a subject identifier, and the like. For example, skill data can indicate that a 6th grade math student is having difficulty with mathematical exponents.

In one embodiment, the disclosure can utilize enhancement data to match a reader with a determined skill deficiency with an appropriate publication. In the embodiment, a target skill within enhancement data can be matched with a skill deficiency within skill data. For example, a book which can help a non-Spanish reader learn vocabulary can be identified and recommended to aid the reader in reading Spanish language texts.

In one instance, profile 112 can include feedback 118 which can be a reader sentiment. In the instance, the reader 119 sentiment can include structured (e.g., questionnaire information) and/or non-structured data about a recommendation 117 (e.g., Book A). In one instance, feedback 118 can be analyzed and used to generate appropriate subsequent recommendation report 114. That is, feedback 118 can be utilized to improve subsequent recommendations associated with the report 114. For example, feedback 118 can include reader's 119 opinions on the Book A and whether the Book A was helpful.

It should be appreciated that the disclosure can assist readers 119 in obtaining individualized recommendations which can help the reader overcome specific obstacles in their learning. In one instance, the disclosure can assist students repeating an educational course due to initial failure to succeed in the course. In the instance, the disclosure can leverage historic performance indicators to determine specific topics (e.g., grammar) which can be problematic for reader 119. In this way, the disclosure can provide individualized recommendations which can target specific problematic topics to aid the reader.

In scenario 110, one or more recommendations 117 can be combined into a recommendation report 114 which can enhance performance associated with learning. Report 114 can include publications (e.g., Book A) which can reinforce a curriculum (e.g., topic) the reader is utilizing. For example, report 114 can include two books which can help a student learn vocabulary necessary for reading an assigned book. Report 114 can include one or more types of publications (e.g., audio/video, books, magazines, electronic articles) which can be obtained from catalog 116. In one instance, report 114 can include location information associated with a recommendation (e.g., 117) which can aid the reader 119 in obtaining the recommendation. Location information can include, but is not limited to, geographic location (e.g., city), regional location (e.g., branch), catalog information (e.g., Dewey Decimal Classification Universal Decimal Classification, Library of Congress Classification), building information (e.g., floor, department), and the like.

In one embodiment, administrative entities 122 can perform evaluation 120 to determine reader performance with a recommendation 117 (e.g., Book A). In the embodiment, entities 122 can obtain reader 119 performance metrics to determine report 114 and/or recommendation 117 impact. For example, a teacher of reader 119 can observe the reader's 119 progress in reading Book A to determine improvement in problematic skills. In one embodiment, evaluation 120 can be utilized to improve recommendation 117 and/or report 114 for reader 119.

It should be appreciated that smarter book selector 150 of scenario 140 can be a generalized component of the disclosure which can include the functionality described within the disclosure. In scenario 140, a user 142 (e.g., student, teacher, parent) can interact with a smarter book selector 150 which can permit one or more actions 144, 146 to be performed. Actions 144, 146 can utilize social media sentiment reporting 152, E-book store 154, and/or standardized testing facility 156. Entities 152, 154, 156 can convey data 160, inventory data 162, and/or results 164 to permit action 144,146 to be appropriately performed. That is, the user 142 can request a recommendation report, receive the result of a recommendation report request, maintain reader profile data, and/or submit findings (e.g., standardized test results) for a reader who has read part or all of the content from a previously generated recommendation report.

In one instance, a user 142 can perform a request recommendation and/or receive recommendation report action 144. In the instance, action 144 can be a search query which can be performed against a publication catalog (e.g., e-book store 154) utilizing a traditional and/or proprietary interface. For example, selector 150 can interact with an electronic book store (e.g., GOOGLE PLAY) such as e-book store 154. In one embodiment, action 144 can utilize social media sentiment data 160 to search inventory 162. In the embodiment, selector 150 can generate a recommendation report from data 160. For example, sentiment reporting 152 can be a FACEBOOK website or a university's social network Web site. It should be appreciated that social media sentiment reporting 152 can include a social networking Web site, a social networking database, and the like. In one embodiment, selector can leverage test scores and/or performance metrics (e.g., results 164) from a standardized testing facility 156. For example, test scores of a reader 119 can determine subjects of difficulty for which recommendations can be generated. Standardized testing facility 156 can include, but is not limited to, a testing center, a testing system (e.g., software), and the like.

In one embodiment, user 142 can perform enter feedback and/or maintain reader profile data action 146. In the embodiment, user entered feedback for realized results and/or profile data can be processed by selector 150 which can be used to continuously improve recommendation accuracy and prowess.

Drawings presented herein are for illustrative purposes only and should not be construed to limit the invention in any regard. It should be appreciated that the disclosure can leverage descriptive bibliographic information to provide an appropriate format for reader 119. It should be appreciated that skill data and/or enhancement data is not the only mechanism which can enable the functionality of the disclosure. Other traditional and/or proprietary mechanisms are contemplated. In one instance, the disclosure can utilize traditional and/or proprietary information filtering systems components to enable the functionality disclosed.

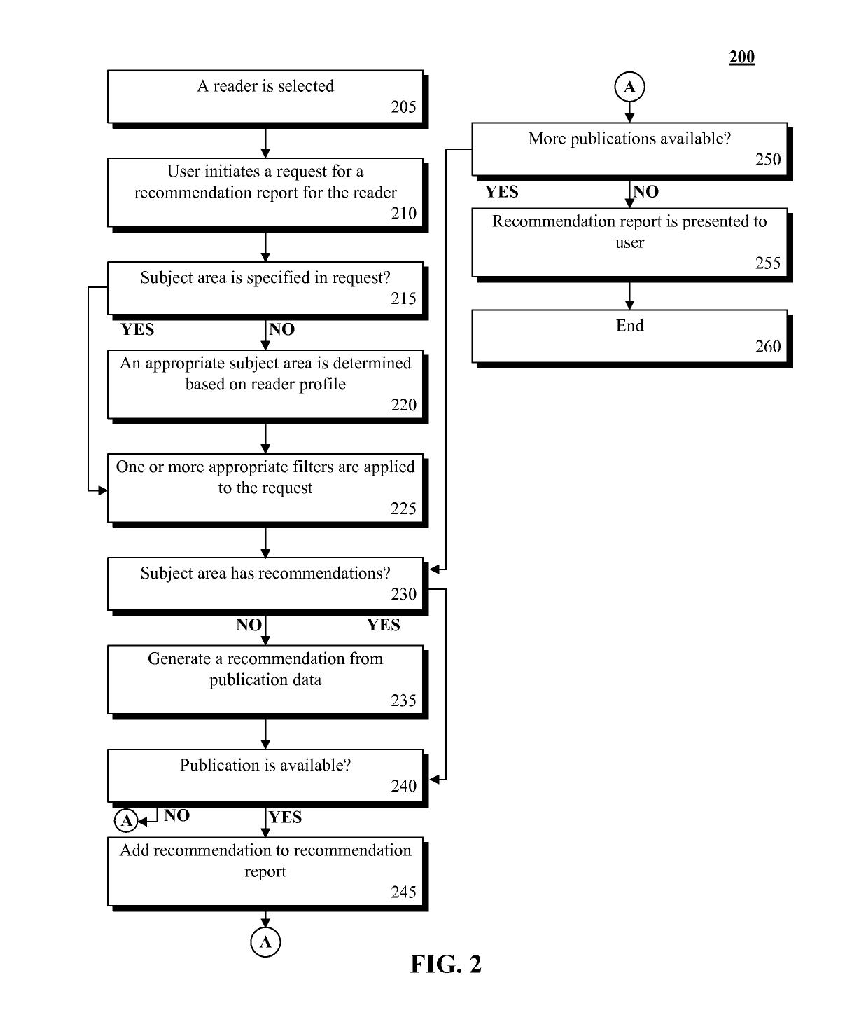

FIG. 2 is a flowchart illustrating a method 200 for leveraging reader performance to provide a publication recommendation in accordance with an embodiment of the inventive arrangements disclosed herein. In method 200, a recommendation report for a reader can be generated utilizing one or more reader profile elements (e.g., test scores). Method 200 can be performed in the context of scenarios 110, 140, system 300, interface 410, 440, and/or embodiment 510, 610. Method 200 can be performed in real-time or near real-time. Method 200 can be performed in serial and/or in parallel.

In step 205 a reader can be selected. Reader selection can be performed manually (e.g., by a user) and/or automatically. Automatic selection can be performed based on one or more criteria including, but not limited to, name (e.g., alphabetical order), performance, age, grade level, activity level, and the like. In step 210, a user can initiate a request for a recommendation report for the reader. In step 215, if a subject area is specified in the request, the method can proceed to step 225, else continue to step 220. In step 220, an appropriate subject area can be determined based on the reader profile. For example, a subject area (e.g., US History) can be established from the curriculum information (e.g., syllabus) associated with a reader profile. In one embodiment, a subject area can be determined through the use of a weighted algorithm with inputs obtained from the reader's profile information including, but not limited to, grade level, current curriculum, areas for improvement, and the like.

In step 225, one or more appropriate filters can be applied to the request. In one embodiment, filters can include, but is not limited to, user input, reader profile settings, system administration settings, and the like. For example, a filter can be utilized to limit book sources based on geographic region. In one instance, filters can include manually and/or automatically established filters. In step 230, if the subject area has no recommendations, the method can continue to step 235, else proceed to step 240. In step 235, a recommendation can be generated from publication data. In one instance, generation can utilize metadata including, but is not limited to, age group, keywords, genre, and the like. For example, content associated with known and significant reading skills improvement capabilities can be selected. In step 240, if the publication is available, the method can continue to step 245, else proceed to step 250. In one instance, availability can be determined based on location, quantities (e.g., limited), or accessibility (e.g., electronic, retail store). For example, the disclosure can take into account one or more potential sources including school and/or community libraries. In step 245, the recommendation can be added to the recommendation report.

In step 250, if there are more publications available, the method can return to step 230, else continue to step 255. In step 255, the recommendation report can be presented to the user (e.g., user interface). In step 260, the method can end. In one embodiment, a report can be conveyed to one or more appropriate entities via traditional and/or proprietary mechanisms. For example, the report can be conveyed via electronic mail to a parent and a teacher. It should be appreciated that steps 230-250 can continue based on publication quantity, recommendation report settings, and the like. For example, the report can be configured to include five recommendations.

Drawings presented herein are for illustrative purposes only and should not be construed to limit the invention in any regard. It should be appreciated that recommendations can be associated with a score which can be utilized to enhance recommendation results. In one embodiment, the method 200 can utilize bookmarks to generate recommendations. In the embodiment, bookmarks can include, but is not limited to, social bookmarks, enterprise bookmarks, and the like.

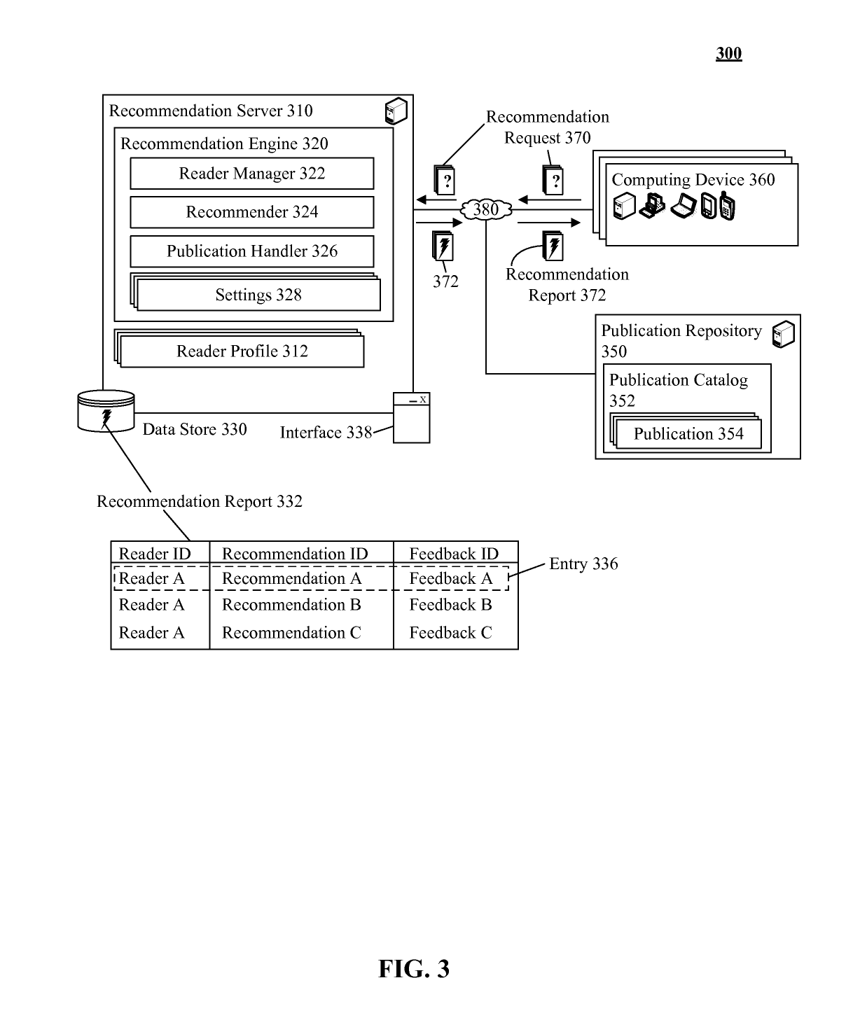

FIG. 3 is a schematic diagram illustrating a system for leveraging reader performance to provide a publication recommendation in accordance with an embodiment of the inventive arrangements disclosed herein. In system 310, a recommendation engine 320 can permit a reader profile 312 to be utilized to generate a recommendation report 332. System 300 components can be communicatively linked via one or more networks 380. System 300 can be present in the context of scenario 110, 140, method 200, interface 410, 440, and/or embodiment, 510, 610.

Recommendation server 310 can be a hardware/software entity for executing engine 320. Server 310 can include, but is not limited to, engine 320, profile 312, data store 330, interface 338, and the like. Server 310 functionality can include, but is not limited to, file sharing, encryption, and the like. In one embodiment, server 310 can be present within a Service Oriented Architecture (SOA). In one instance, recommendation server 310 can receive a recommendation request 370 from computing device 360. In the instance, server 310 can convey an appropriate recommendation report 372 to the device 360.

Recommendation engine 320 can be a hardware/software element for generating a recommendation report 332. Engine 320 functionality can include, but is not limited to, anonymization, access control, semantic analysis, search engine capabilities, content-based filtering, data mining, and the like. Engine 320 can include, but is not limited to, reader manager 322, recommender 324, publication handler 326, settings 328, and the like. In one embodiment, engine 320 capability can be present within a publication repository search functionality. In another embodiment, engine 320 can be present within a curriculum management software.

In one embodiment, engine 320 can utilize collaborative filtering techniques to generate publication recommendations. In the embodiment, filtering can include matrix factorization algorithms, low-rank matrix approximation algorithms, and the like.

In another embodiment, engine 320 can utilize tagging metadata associated with publications, bookmarks, social media data, and the like. In the embodiment, metadata can include, but is not limited to, knowledge tags, organizational tags, and the like.

Reader manager 322 can be a hardware/software entity for handling reader profile 312 and/or metadata associated with a reader. Manager 322 functionality can include, but is not limited to, reader registration, profile 312 acquisition, profile creation, profile management, and the like. In one instance, manager 322 can communicate with traditional and/or proprietary systems to obtain profile data. In the instance, profile data can include, but is not limited to, name, age, grade level, performance metrics, and the like. In one embodiment, manager 322 can support groups (e.g., learning groups, teams).

Recommender 324 can be a hardware/software element for determining a publication recommendation based on a reader profile. Recommender 324 functionality can include, but is not limited to, recommendation scoring, recommendation generation, and the like. In one instance, recommender 324 can permit a recommendation and/or recommendation report to be associated with a rating system. In the instance, the rating system can conform to conventional (e.g., five star) or non-conventional rating schemes. In one embodiment, recommender 324 can utilize traditional and/or proprietary algorithms (e.g., analytics) to generate recommendations, rate recommendations, and the like. For example, recommendations can be rated by users (e.g., readers, parents, teachers) based on the usefulness of the recommendation. In one instance, recommender can be utilized to receive feedback on a per recommendation basis and/or a per recommendation report basis.

Publication handler 326 can be a hardware/software entity for managing publications 354 associated with a catalog 352 within repository 350. Handler 326 functionality can include, but is not limited to, repository registration, publication catalog registration, data exchange, and the like. In one instance, handler 326 can be utilized to dynamically locate appropriate publication 354 formats. In another instance, handler 326 can be utilized to query repository 350 and/or catalog 352. In one instance, handler 326 can utilize existing analytics to determine publication complexity, suitability, and the like. In another instance, handler 326 can utilize traditional and/or proprietary analytics (e.g., lexical analysis) to determine relevant publications 354.

Settings 328 can be one or more configuration options for establishing the behavior of system 300, server 310, and/or engine 320. Settings 328 can include, but is not limited to, manager 322 options, recommender 324 settings, handler 326 options, profile 312 settings, and the like. In one embodiment, settings 328 can be manually and/or automatically established. In one instance, settings 328 can be presented within interface 338, within an interface communicatively linked to device 360, and the like.

Reader profile 312 can conform to a traditional and/or proprietary format, including, but not limited to, Extensible Markup Language (XML), Hypertext Markup Language (HTML), and the like. In one embodiment, profile 312 can be a social networking profile. In another embodiment, profile 312 can be dynamically assembled from data and/or metadata obtained from systems communicatively linked with server 310. Profile 312 can include explicitly collected data, implicitly collected data, and the like.

Data store 330 can be a hardware/software component able to persist profile 312, report 332, and the like. Data store 330 can be a Storage Area Network (SAN), Network Attached Storage (NAS), and the like. Data store 330 can conform to a relational database management system (RDBMS), object oriented database management system (OODBMS), and the like. Data store 330 can be communicatively linked to server 310 in one or more traditional and/or proprietary mechanisms. In one instance, data store 330 can be a component of Structured Query Language (SQL) complaint database.

Recommendation report 332 can conform to one or more traditional and/or proprietary formats. Report 332 can be dynamically updated based on profile 312 and/or feedback. Report 332 can include text elements, graphical elements, and the like. Report 332 can include a reader identity, a recommendation identity, a feedback identity, and the like. For example, report 332 can include an entry 336 which can link a Reader A with a Recommendation A and a Feedback A. That is, user specific feedback can be tied to a recommendation permitting customized recommendation reports to be continually enhanced. In one instance, report 332 can present performance metrics associated with historic usefulness of a recommendation. In one embodiment, report 332 can be persisted within computing device 360 (e.g., cached), repository 350, and the like.

Interface 338 can be a user interactive component permitting interaction and/or presentation of report 332, profile 312, and the like. Interface 338 can be present within the context of a Web browser application, an electronic learning software (e.g., BLACKBOARD), and the like. In one embodiment, interface 338 can be a screen of a Rich Internet Application (RIA). Interface 338 capabilities can include a graphical user interface (GUI), voice user interface (VUI), mixed-mode interface, and the like. In one instance, interface 338 can be communicatively linked to computing device 360.

Computing device 360 can be a hardware/software permitting the execution and/or presentation of report 332. Device 360 can include, but is not limited to, device 360 settings, an interface, and the like. Computing device 360 can include, but is not limited to, a desktop computer, a laptop computer, a tablet computing device, a personal digital assistant (PDA), a mobile phone, and the like. In one instance, device 360 can be a computer communicatively linked to an electronic learning system, a digital library, and the like.

Publication repository 350 can be a hardware/software entity for persisting publication catalog 352 and/or publication 354. Repository 350 can include but is not limited to one or more publication catalogs 352. For example, repository 350 can be a digital representation of a national library. Catalogs 352 can include one or more publications 354. Publications 354 can include digital and/or analog resources. Resources can include, but is not limited to books, magazines, newspapers, recorded media (e.g., CDs, DVDs, audio tapes), microfiche, Web sites, electronic articles, and the like. Repository 350 can include public and/or private digital libraries. Repository 350 can conform to traditional and/or proprietary formats. Repository 350 can be associated with one or more security measures including, firewalls, encryption, and the like.

Network 380 can be an electrical and/or computer network connecting one or more system 300 components. Network 380 can include, but is not limited to, twisted pair cabling, optical fiber, coaxial cable, and the like. Network 380 can include any combination of wired and/or wireless components. Network 380 topologies can include, but is not limited to, bus, star, mesh, and the like. Network 380 types can include, but is not limited to, Local Area Network (LAN), Wide Area Network (WAN), Virtual Private Network (VPN) and the like.

Drawings presented herein are for illustrative purposes only and should not be construed to limit the invention in any regard. It should be appreciated that polymorphic engine 320 can include optional components permitting the functionality of engine 320 is retained. It should be appreciated that one or more components within system 300 can be optional components permitting that the disclosure functionality be retained. It should be appreciated that one or more components of engine 320 can be combined and/or separated based on functionality, usage, and the like. In one embodiment, engine 320 can be utilized to leverage the functionality of legacy systems (e.g., DYNIX) and non legacy systems (e.g., Online Public Access Catalog). In one instance, engine 320 can leverage Multimedia Information Retrieval (MIR) systems. For example, the engine 320 can utilize information extraction to enable recommendation generation and/or feedback analysis.

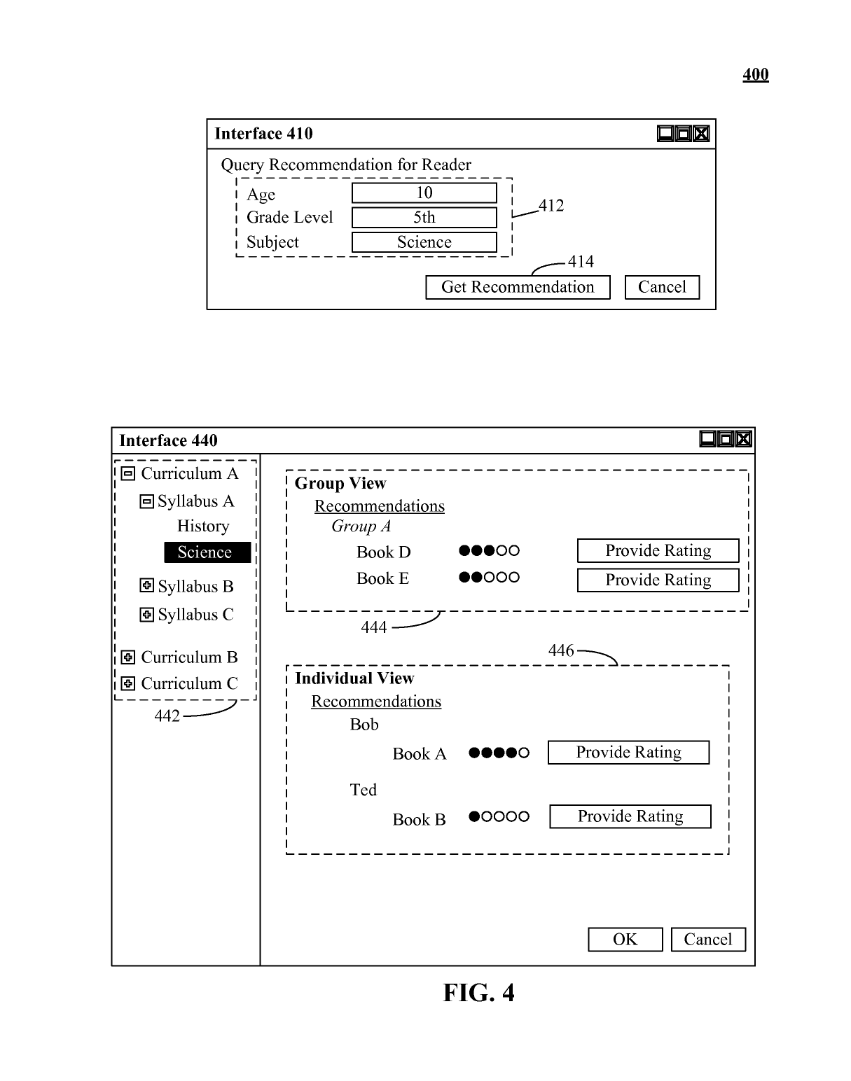

FIG. 4 is a schematic diagram illustrating a set of interfaces 410 440 for leveraging reader performance to provide a publication recommendation in accordance with an embodiment of the inventive arrangements disclosed herein. Interface 410, 440 can be present in the context of scenario 110, 140, method 200, system 300, and/or embodiment 510, 610. In interface 410, search parameters for a recommendation associated with a reader can be inputted. In interface 440, one or more recommendation reports can be presented within interface 440.

In interface 410, one or more search criteria 412 can be selected by a user to obtain a recommendation for a reader. In one instance, search criteria 412 can include, but is not limited to, age, grade level, subject, genre, text complexity, rating, recommendation quantity, publication location, and the like. For example, a user can search for Science recommendations for a ten year old reader in the 5th grade. In one embodiment, interface 410 can include one or more interface elements 414 which can enable the submission of a query associated with criteria 412. For example, a “get recommendation” button can trigger a recommendation request on criteria 412.

In interface 440, one or more recommendation reports can be presented. In one instance, recommendation report can include subdivisions 442, group recommendations 444, and/or individual recommendations 446. In one embodiment, subdivisions 442 can enable multiple recommendations from multiple reports to be compiled into a single interface 440. Subdivisions 442 can enable separation of reports by curriculum, course, syllabus, subject area, and the like. In group recommendations 444, recommendations for one or more previously established groups can be presented. Recommendations 444 can include, group descriptors, recommendation information (e.g., book name), rating information, feedback interface elements (e.g., Provide Rating button), and the like. Individual recommendation 446 can include individual descriptors (e.g., names), recommendation information (e.g., book name), rating information, feedback interface elements (e.g., Provide Rating button), and the like.

Drawings presented herein are for illustrative purposes only and should not be construed to limit the invention in any regard. It should be appreciated that interface 410, 440 can include one or more interface elements such as push buttons, checkboxes, radio buttons, and the like. It should be appreciated that interface 410, 440 can be associated with a Web based interface, a desktop application interface, a mobile application interface, and the like.

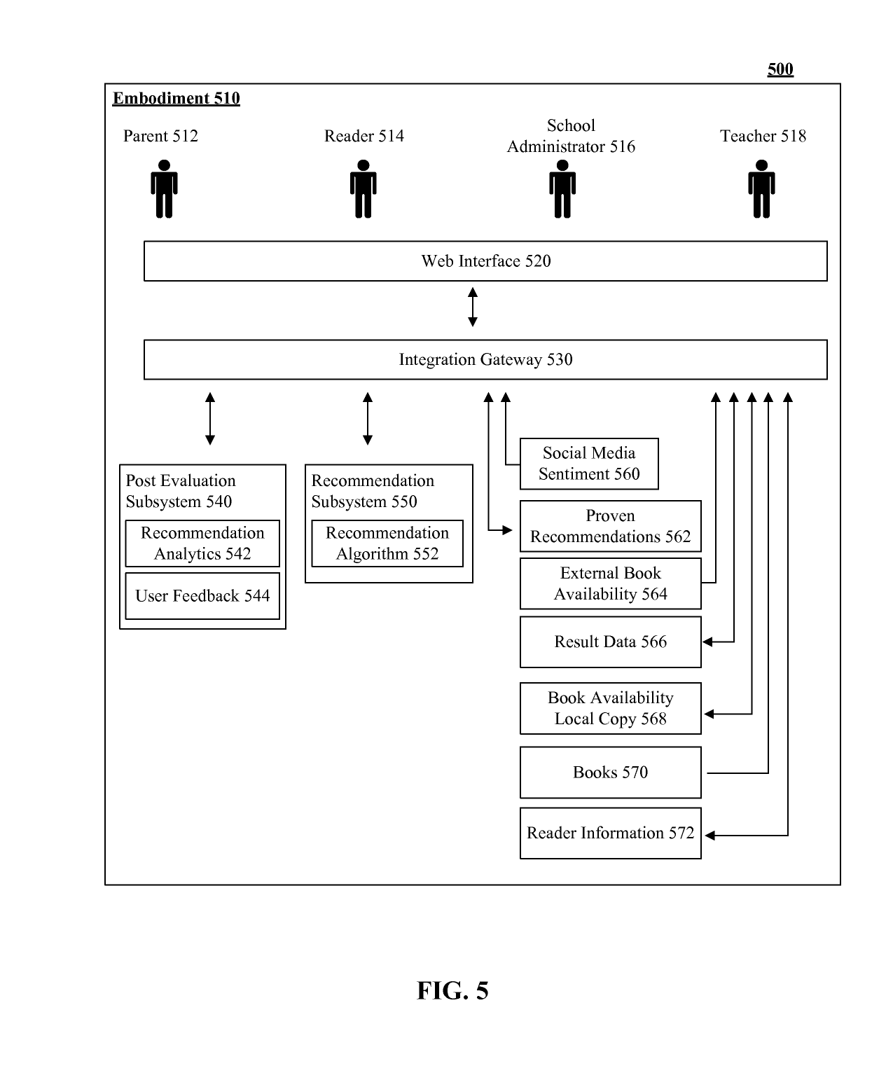

FIG. 5 is a schematic diagram illustrating an embodiment 510 for leveraging reader performance to provide a publication recommendation in accordance with an embodiment of the inventive arrangements disclosed herein. Embodiment 510 can present an architectural diagram depicting four types of users (e.g., parent 512, reader—student 514, school administrator 516, and teacher 518) accessing the Smarter Book Selector through a Web interface 520. The interface can appear different depending on which type of user is utilizing the interface 520. That is, presentation of actions inappropriate for each role can be suppressed. The Web Interface 520 component can communicate with the Smarter Book Selector subsystems 540, 550 and databases 560-572 through an integration gateway. Communication can feature standardized messaging formats and/or services. The Post Evaluation Subsystem 540 can collect user feedback 544 (e.g., findings) and perform analytics to drive “learning” toward recommendation improvements. The Recommendation Subsystem 550 can employ algorithms that leverage user input, previous track records, book catalog data, and online social media sentiment to arrive at content assessments that can become new recommendations.

The Integration Gateway 530 component can serve as the connection point for all off-board data, systems, and users affected by the Smarter Book Selector's execution component. The gateway 530 can manage disparate and connected systems supporting working, user profile, and historical/track record data. It should be noted that such systems “internal” to the Smarter Book Selector's evaluation, assessment, and “learning” functions, while distributed, can still be managed as internal and considered as “lumped into” the Smarter Book Selector, as opposed to the aforementioned “external” e-Book Store, Standardized Testing Facility, and Social Media Reporting systems.

As used herein, result data 566 can include information, both fed back and acquired, for observed and tested effects of reading content on specific student profiles. Reader information 572 can house “profiles” related to targeted student readers, (e.g., name, age, grade level, previous publications read, current curriculum, desired improvement areas, and local content availability). Books 570 can bring together content-specific metadata like ISBN, title, author, genre, time period, tag words, literary themes, and targeted age groups. Proven recommendations 562 can provide “tried and true” publications with known and successful track records for reader improvement. External book availability 564 can pinpoint physical locations and availabilities associated with cataloged content associated with the books 570 data source. That is, the availability 564 can be represented by acquisition and compilation of findings from externally-managed commercial and government sources such as booksellers and accessible libraries. Book availability local copy 568 can be cached location and availability information for cataloged content in order to support connectivity interruptions and offline operation. Social media sentiment 560 can include sentiment information on books known to the Smarter Book Selector, gathered and synthesized from social media sources. Media sources can include, but is not limited to, FACEBOOK, MYSPACE, LINKEDIN, TWITTER, and the like. In one instance, sources can include e-Commerce sites (e.g., user-supplied reviews). In the instance, e-Commerce sites can include, but is not limited to, AMAZON.COM, BARNES AND NOBLE, GOOGLE BOOKS, APPLE ITUNES, and the like.

Parent 512 can be a caretaker whose child is a targeted reader, and who is allowed appropriate access to records, recommendations, and results in accordance with their parental role. Reader 514 can be a student or otherwise who becomes the target for content recommendations, and having recorded attributes that include age, grade level, curriculum, current learning focus, reading history, desired improvement areas, and pertinent restrictions. School administrator 516 can be responsible for shaping curricula for “readers” on a school- or district-wide basis, and having access to records, recommendations, and results in accordance with the administrative role. Administrator 516 can include principals, counselors, academic advisors, librarians, and others in educational authority positions. Teacher 518 can be a reader's specific and assigned instructor, accountable for student progress toward learning goals, milestones, and measurements.

Component subsystems pertinent to the Smarter Book Selector's operations can include subsystem 540, 550. Recommendation subsystem 550 can receive user request input, and can pull data from various sources, internal (e.g., to the Smarter Book Selector) and external, and implements logic required to generate and deliver recommendation lists for targeted and identified (e.g., “profile” information existing and present) readers. Post evaluation subsystem 540 can be used by content readers or requesters to confirm completion of recommended content and potentially the recording of significant reader improvement metrics evident afterward. Collected data can contribute to individual content's “track record” and proven reuse potential, as well as to the effectiveness of the algorithms used to conceive and generate recommendations.

Web Interface 520 can be used to accept input for the purposes of generating recommendation requests, submitting post evaluations, and managing reader “profile” information and preferences. Recommendation subsystem 550 primary function can be to provide content recommendation matching services, also leveraging consumer sentiment analysis where applicable to content known to the Smarter Book Selector.

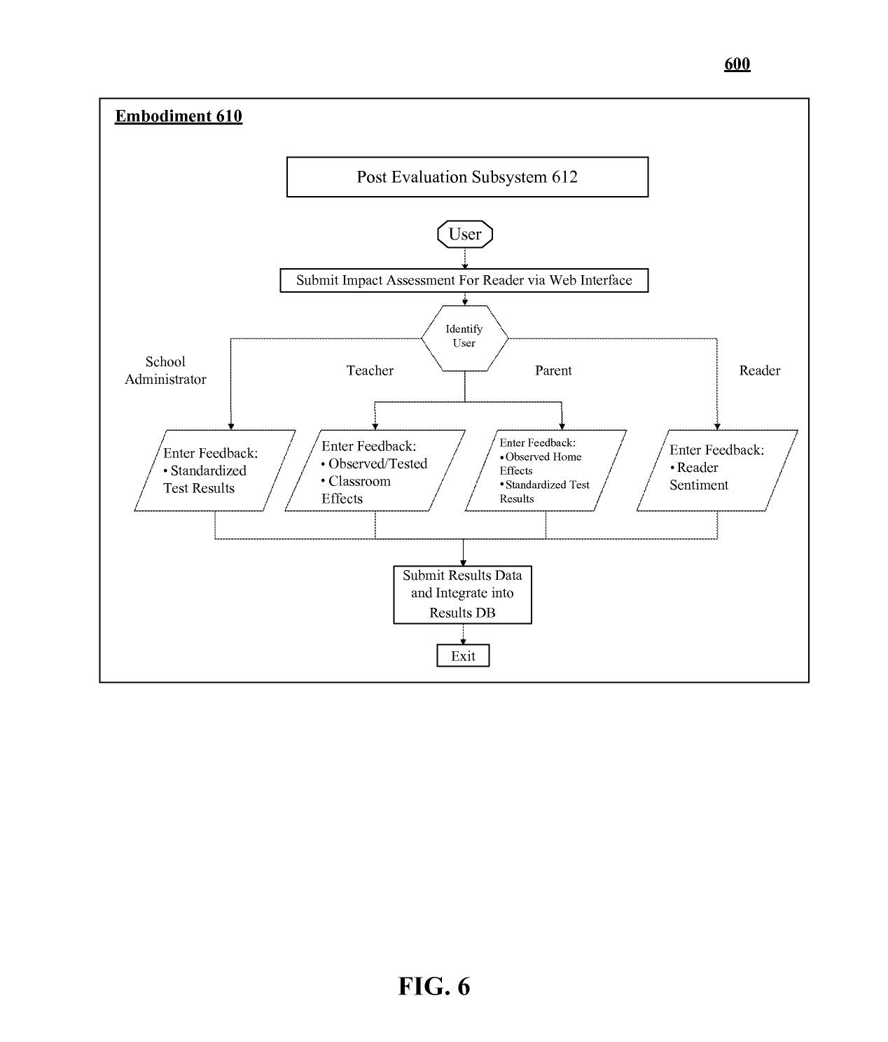

FIG. 6 is a schematic diagram illustrating an embodiment 610 for leveraging reader performance to provide a publication recommendation in accordance with an embodiment of the inventive arrangements disclosed herein. In embodiment 610, a finding submission functionality can be presented. Embodiment 610 can be performed in the context of scenario 110, 140, method 200, system 300, interface 410, 440 and/or embodiment 510.

In embodiment 610, a user can submit an impact assessment (e.g., observed and/or tested effects) for a specified reader via the Smarter Book Selector Web interface. The user can be a parent, teacher, school administrator, or the reader themselves. The user can be identified in one of the role types known to the system, which determines the kind of feedback appropriate for acceptance and eligible for submission. A parent can submit feedback regarding observed and attributable home effects (e.g., unstructured data) and standardized test scores (e.g., structured data). A teacher can submit feedback regarding observed effects and behavior (e.g., unstructured data) and tested effects (e.g., structured data) in the classroom. A school administrator can submit feedback regarding standardized test scores. A reader can submit feedback regarding personal sentiments and impressions (e.g., unstructured data). Upon a user's submission of an impact assessment, results feedback is integrated into the Smarter Book Selector's results data source and the findings submission process can exit.

The flowchart and block diagrams in the FIGS. 1-6 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for providing recommendations comprising:
identifying a user associated with an educational institution, wherein the institution comprises of at least one curriculum, wherein the user is associated with a profile, wherein the profile is comprised of a plurality of characteristics associated with the user, wherein the plurality of characteristics is at least one of a skill associated with the curriculum and a performance indicator associated with the skill, wherein a skill is a learned capacity to carry out a pre-determined result;
analyzing the plurality of characteristics of the profile to determine at least one of a proficiency and a deficiency in the skill associated with the user, wherein the analyzing evaluates the performance metric associated with the skill; and
determining an enhancement data associated with a publication within a publication repository, wherein the enhancement data comprises of at least one of target skill and a target characteristic, wherein the publication repository is at least one of an electronic catalog and physical library, wherein the publication is at least one of a physical media and an electronic media.

2. The method of claim 1, further comprising:
presenting the publication within a user interface responsive to a selection of the publication.

3. The method of claim 1, wherein the characteristics comprise at least one of an age, a grade level, and presence information.

4. The method of claim 1, further comprising:
matching a target skill of an enhancement data associated with a publication with a skill deficiency associated with a user based on the user profile.

5. The method of claim 1, wherein the skill is at least one of a literacy skill and a mathematical skill.

6. The method of claim 1, further comprising:
establishing a plurality of locations associated with the recommended publication; and
analyzing presence information associated with the user to determine a proximate location associated with the recommended publication, wherein the proximate location is a region proximately located to the user, wherein the presence information is a geographical information.

7. The method of claim 1, wherein the enhancement data is a skill requirement for successfully interacting with the publication.

8. The method of claim 1, further comprising:
automatically collecting feedback from the user responsive to interaction with the publication.

9. The method of claim 1, further comprising:
programmatically improving the determining utilizing at least one of metrics and a social networking sentiment.

10. A system for providing publication recommendations comprising:
a recommendation engine configured to provide a recommendation report based on a reader, wherein the recommendation report is comprised of recommended publications associated with characteristics of the reader, wherein the characteristics is at least one of a skill associated with a subject area of a curriculum and a performance indicator associated with the skill, wherein a skill is a learned capacity to carry out a pre-determined result; and
a data store able to persist at least one of a curriculum, a publication recommendation, a reader profile, and a configuration setting.

11. The system of claim 10, further comprising:
a reader manager configured to determine at least one of a skill proficiency and a skill deficiency from the plurality of characteristics associated with the reader;
a recommender able to determine a publication recommendation based on the plurality of the characteristics, wherein the publication recommendation is a publication targeting the at least one of the skill proficiency and skill deficiency; and
a publication handler configured to analyze a publication within a publication repository to determine an enhancement data, wherein the enhancement data is at least one of a target skill data, wherein the target skill data comprises of a skill.

12. The system of claim 10, wherein the recommendation report is conveyed to a plurality of administrative entities associated with the reader.

13. The system of claim 10, wherein the reader manager is able to automatically collect feedback associated with interaction with a publication recommendation.

14. The system of claim 10, wherein the recommender is configured to analyze presence information associated with the user to determine an appropriate publication, wherein the presence information is a geographical information.

15. The system of claim 10, further comprising:
a rating component configured to receive a rating associated with a publication recommendation, wherein the rating is an evaluation of the success of the recommendation, wherein the rating is at least one of a score value and a confidence value.

16. The system of claim 15, further comprising:
the rating component automatically improving the recommendation report responsive to the receiving.

17. The system of claim 10, wherein the reader manager is configured to automatically collect feedback from a social networking data source, wherein the data source is at least one of a social networking Web site and a social media Web site.

18. The system of claim 10, wherein the reader manager is configured to receive a performance metric associated with a skill from a standardized testing facility.

19. A computer program product comprising a computer readable storage medium having computer usable program code embodied therewith, the computer usable program code comprising:
computer usable program code stored in a storage medium, if said computer usable program code is executed by a processor it is operable to receive a user input from a user, wherein the user input is a search criteria, wherein the criteria is at least one characteristic associated with a reader, wherein the characteristic at least one of a grade level and skill proficiency associated with a reader;
computer usable program code stored in a storage medium, if said computer usable program code is executed by a processor it is operable to querying a publication repository to determine a publication appropriate for the reader based on the characteristic; and
computer usable program code stored in a storage medium, if said computer usable program code is executed by a processor it is operable to presenting a result associated with the query, wherein the result is a recommended publication based on the search criteria, wherein the recommended publication is at least one of a physical media and an electronic media, wherein interaction with the recommended publication results in improving a characteristic associated with the reader.

20. The system of claim 19, wherein the characteristic is a skill, wherein the skill is at least one of a literacy skill and a mathematical skill.
